(19) United States
(12) Patent Application Publication
(10) Pub. No.: US 2008/0234023 A1
(43) Pub. Date: Sep. 25, 2008

(54) LIGHT GAME

(76) Inventors: Ajmal Mullahkhel, West Valley City, UT (US); Farhad Mullahkhel, West Valley City, UT (US); Jason Willett, West Valley City, UT (US)

Correspondence Address: BATEMAN IP LAW GROUP, P.O. BOX 1319, SALT LAKE CITY, UT, 84110, US

(21) Appl. No.: 12/052,687

(22) Filed: Mar. 20, 2008

Related U.S. Application Data
(60) Provisional application No. 60/896,802, filed on Mar. 23, 2007.

(51) Int. Cl. A63F 13/00

(52) U.S. Cl. 463/7; 463/39

(57) ABSTRACT

A game and system allow a person to learn and practice dance techniques involving the movement of glowing objects to thereby create a light show, commonly known as glow sticking or stringing. The system utilizes motion sensitive controllers to sense a person's movements and displays the resulting dance moves on an electronic display.

### RELATED APPLICATIONS

The present application claims the benefit of U.S. Provisional Application Ser. No. 60/896,802, filed Mar. 23, 2007, which is incorporated herein in its entirety.

### BACKGROUND OF THE INVENTION

1. The Field of the Invention

The present invention relates to a game which allows individuals to develop and practice their skills in dancing with illuminated objects to thereby create light patterns or a light show. The game also tests the skills of individuals in the performance of such a light show. The game is useful for simulating the arts of “glow sticking” and “stringing.”

2. State of the Art

It has become popular to dance while holding or otherwise moving an illuminated object. Dancing while holding a light emitting object has become known as “glow sticking” or “stringing.” Such dancing is often performed at night or in a dimly lit room so as to make the light patterns from the glowing object more readily visible to the person and to the spectators.

The light emitting objects may be glow sticks, glow-in-the-dark objects, LED illuminated objects, etc. Glow sticks emit colored light via a chemical reaction occurring within a translucent tube, and are known in the art. In glow sticking, an individual holds one or more glow sticks or other light emitting objects while dancing. The person may often hold the glow sticks in their hands and move their hands rapidly so as to create different light designs in the air with the glow sticks. When the individual moves quickly, the light from the glowing object(s) creates light trails or patterns which are visually pleasing to observers.

Another such form of dancing is referred to as stringing. When a person is stringing, glowing devices such as glow sticks are attached to the end of a string and the user swings or moves the string around, often at a rapid speed. Stringing allows a person to create a larger light show and more rapid movement of the glow sticks.

Dance forms such as glow sticking or stringing are not limited to using only glow sticks, but may involve many different types of glowing objects. Some persons may use LED's mounted to a ring, stick, or the like to create the glowing light. The LED's may provide a number of different colors of light, and may also flash, change color, or create many lighting effects. Many glowing objects may thus be used.

The optical effect created while dancing may vary considerably. It is appreciated that if the glowing object is moved quickly in a pattern, such as a circle, that pattern appears to be continuously illuminated. Thus, a person may move the glowing objects in different patterns and using different techniques while dancing to create different lighting effects. Many techniques and moves may be quite complicated and require practice to perfect.

Glow sticking and stringing have become very popular at youth dances. Thus, many youth desire to know how to perform the art form well. Learning the art, however, can take considerable practice and teaching to obtain correct hand movements and to achieve the desired optical effect.

One challenge with glow sticking is that it is difficult for an individual to simultaneously perform the hand movements necessary and to watch to see how well the optical effect is being created. Thus, there is a need for a way for individuals to more easily observe their own dance movements when practicing or learning new dance moves. Additionally, persons often will observe new dance moves when these moves are performed at a dance by another person. The observer will desire to learn these moves, but may not adequately remember the move and will often not know how the move was performed. There is a need for a device which can help people learn desired dance moves and techniques as well as practice the dance moves.

Additionally, competitions can develop between individuals regarding who is better at performing various routines. Currently, any competition between individuals is very subjective and relies on third parties to determine who is doing a better job in the performance. There is little objective judging of the level of difficulty or of the accuracy of a performance. Additionally, competitions must currently be performed with both persons in the same location, preventing competition between persons located in different geographic areas. Thus, there is a need to facilitate competition between individuals in any location and to provide methods of judging the competition. There is a need for connecting dancers, such as those from different geographic regions, with each other for practice or dance sessions to demonstrate skills or teach new moves. Being able to connect dancers for competition or practice improves the ability of contestants and can allow for hours of entertainment.

### SUMMARY OF THE INVENTION

It is an object of the invention to create a system which can be used to assist individuals in developing their skills at glow sticking or stringing. Another object of the invention is to provide a game environment where individuals can compete with themselves or others to test their skills in these art forms, or may teach other dance moves or techniques.

A system in accordance with the present invention includes an electronic gaming system and one or more handheld controllers which generate a signal indicative of the hand movements of the user. The signal is transmitted from the controller to the gaming system which processes the hand movements and generates an optical representation of the hand movements on a display device, such as a television. In one typical embodiment, handheld controllers are held in a user's hand while they perform the hand movements for a particular element of a glow sticking or stringing routine. The 3-dimensional movements of the users hand are transmitted to a processor such as a computer or a gaming device, such as a SONY PLAYSTATION®, a MICROSOFT XBOX®, or a NINTENDO WII®. The processor then sends signals to a television where light patterns are shown similar to how the movement would be seen by someone observing the glow sticking or stringing exhibition.

In accordance with one aspect of the invention, the system may be programmed with a specific routine. The signals from the controllers are compared to the movements which should be performed for the particular maneuver and the individual is scored as to how well the movements followed the designated movements necessary to properly perform the maneuver. Additionally, the user can watch the light show on the monitor to see how well the technique was performed.

In accordance with one aspect of the present invention, the system can be adjusted to account for different levels of ability and sophistication of the techniques. Thus, for example, the system may have a beginning, intermediate, and advanced level. Beginning levels would include relatively simple maneuvers which may be performed at a relaxed pace. As levels increase, the techniques would become increasingly difficult and/or would require the techniques to be performed at a greater speed or with greater accuracy.

In accordance with one aspect of the invention, the system can be configured to receive input from two or more individuals. The individuals could be scored against each other and the monitor could be configured to display the performances of each individual so that they can be subjectively compared. Preferably, the system is configured to enable competition between two individuals in a common location, and to accommodate remote competitions, such as via the internet or other communications protocol so that individuals could compete or otherwise compare their performances with individuals from all over the world.

In accordance with another aspect of the present invention, the controller may be provided with one or more lights so as to simulate the optical effect of dancing with glow sticks or other similar light sources. Alternatively, a commercially available controller such as the Wii® remote may be used.

### BRIEF DESCRIPTION OF THE DRAWINGS

Various embodiments of the present invention are shown and described in reference to the numbered drawings wherein:

FIG. 1 shows a perspective view of a system of the present invention;

FIG. 2 shows a perspective view of the controller of the present invention;

FIG. 3 shows a perspective view of the system of the present invention; and

FIG. 4 shows a perspective view of the display of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

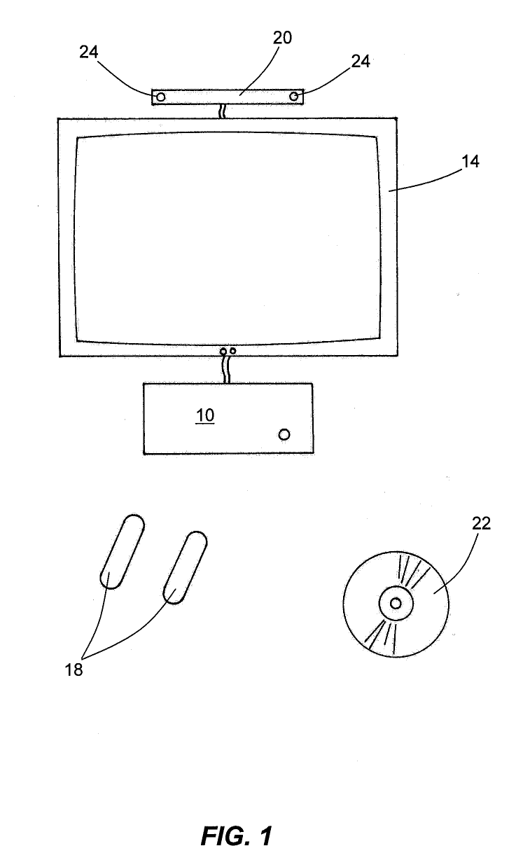

Turning now to FIG. 1, a perspective view of a system for practicing glow sticking and the like. The system includes a processor 10, which may be, without limitation, a computer or a commercially available gaming system. The processor 10 is connected to a display 14, such as a television, and controllers 18. The controllers 18 are preferably wireless controllers, such as are available with the NINTENDO WII®, as wireless controllers will make it easer to perform the desired dance moves without becoming entangled in controller wires. The controllers 18 are motion sensitive such that the various movements of the controller as made by a person are sensed by the controller and transmitted to the processor 10.

It is known in the art to make a video game controller which is wireless and motion sensing. The present invention, however, preferably comprises a pair of controllers which are both wireless and motion sensing and which are not connected to each other by wires. This can be accomplished in a variety of ways, such as three dimensional switches or accelerometers which configured to monitor movement in three dimensions.

According to one aspect of the invention, commercially available handheld controllers such as those available for the NINTENDO WII® may be used. As these controllers (often casually referred to as the Wiimote) are similar to other motion sensing controllers, the implementation of a Wiimote or another controller using a three axis accelerometer will be similar, and forms the basis of the present discussion. Motions of the controller are, unless otherwise noted, discussed with the controller held upright with the front facing away from the user.

The Wiimote includes a three axis linear accelerometer (Analog Devices ADXL330) in the front portion of the controller to sense movement. The accelerometer has a range of about 3 times the force of gravity. Such an accelerometer is typical of the type of controller used for the present system. The accelerometer is affected by gravity, and will thus display a vertical acceleration when standing still, and no vertical acceleration if free-falling. This phenomenon is used to calculate the pitch and roll of the controller. Rotation of the controller can be calculated if there is no external acceleration acting on the device. Yaw of the controller can be calculated with an additional infrared camera mounted to the controller and an infrared light source 20 which is typically mounted adjacent the display 14. The infrared light source 20 commonly used is a bar shaped device which has two infrared LEDs 24 mounted therein. The use of the infrared light source 20 allows the controller 18 to be calibrated in order to determine where the controller is pointed (so long as the infrared light source is visible).

The present invention may frequently utilize the controller 18 in a manner where an infrared light source 20 will not always be visible to the controller. As such, other methods may be required to track the motion of the controller 18 and determine user inputs for controlling the system. One method of determining input signals from the controller is by using jerk based input signals. In this method, the acceleration values from the accelerometers are constantly measured and predetermined behavior is triggered when an acceleration value exceeds a predetermined value.

Another method of determining input signals from the controller is by using gestures. using gestures to determine user inputs involves determining the various dance moves/techniques which are recognized by the processor 10 and software 22, using the desired controller to perform the various dance moves, and determining average acceleration values sensed by the controller accelerometer and using these average values to gauge actual user input while the user participates in the dance game.

First, a number of different dance moves are defined as may be used while playing the dance game. The dance moves may be a complete sequence whereby a user would move an illuminated object when glow sticking or stringing. Alternatively, the dance moves may be smaller building block like movements which are performed in sequence to perform a longer dance move. The present system may utilize a combination of these larger and smaller move sequences as well as utilizing a number of common larger sequences of smaller move sequences, allowing a person to both perform standard moves as well as create their own moves. Each of the separate dance move sequences or the larger string of sequences is defined as a separate gesture.

Once the various dance move gestures are defined, a controller is used to record the gestures. The recorded gesture is the output signals from the 3 axis accelerometer. The gesture is typically recorded a number of times with some variation, and these multiple recorded gestures are averaged together and interpolated (such as by using a cubic spline interpolation) to populate the desired data points. Thus, the average of gesture recordings will represent the average correct execution of the dance move, and may also include the standard deviation from the average. As such, the recorded gesture may include a range of controller movements which correctly executes the desired dance move, and may be used to calculate how closely a person performs the dance move.

Typically, the gestures are normalized both in acceleration magnitudes and in time duration. The normalized time and acceleration values for a gesture may be used to determine if a person is performing the relevant dance move quickly or slowly, or if the person is performing the dance move using large or small movements.

When a person is using the present system to perform various dance moves (whether this be in practicing, competition, etc.) the processor 10 monitors the acceleration values reported by the controller and determines which dance moves are being performed by the person. The performed dance moves are animated and displayed on the display 14. The person may use the buttons on the controller to indicate the start and stop of dance moves. Alternatively, the processor 10 may independently determine if the person has completed a defined dance move, which may be a sequence of smaller gestures.

The system may also allow the person to perform free form dance moves which do not correspond to longer predetermined dance moves. This may largely be accomplished by the game recording gestures for shorter dance moves which may be used as building blocks for longer dance moves. Thus, the gestures may include a variety of simple movements such as moving the controller up or down, left or right, spinning or turning the controller, moving the controller in a circle, swinging the controller on a string, etc. All of the various movements commonly used in glow sticking or stringing may be programmed into the software 22 as gestures, allowing a person to create their own custom dance moves and routines in real time while using the system.

In judging how well a person performs dance moves or a predetermined dance routine, various factors may be used. The smoothness with which a person performs moves may be utilized. Additionally, the speed or size magnitude (whether the move is performed in a small and calmer fashion or is performed in a large and excited fashion) may be used to determine how well a person has performed a dance move.

The software 22 may also allow a user to record movements corresponding to the various gestures so that the processor 10 recognizes the user's inputs more readily. This may allow a user to customize the software somewhat and more easily perform the dance moves. This may, however, make it more difficult to determine if a person has performed the dance moves “correctly” and as such it may not be desirable, especially for contests between different persons.

Software 22 is provided which is programmed as necessary for the processor 10 and controllers 18. The software 22 is programmed as is necessary for the desired processor 10, and as such may be offered for a variety of different gaming platforms. One of skill in the programming art will understand how the software will be programmed to accomplish the various game functions for the desired processor 10.

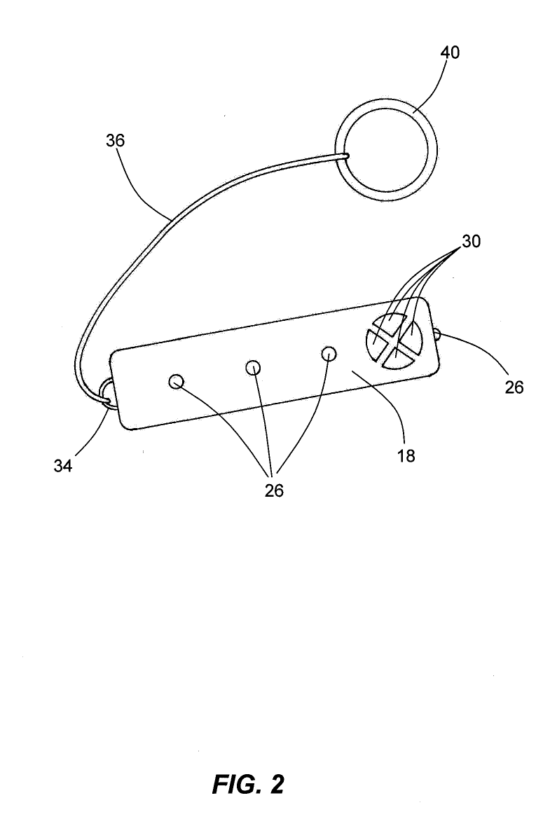

Turning now to FIG. 2, a top view of a controller 18 of the present invention is shown. According to the invention, the controller may be constructed with additional features not known for standard video game controllers. The controller 18 may include one or more lights 26, such as LED's, mounted thereon. The LED's may be illuminated while the controller is in use to thereby better simulate a glow stick. The controller 18 will typically include buttons 30 used to start or stop the game, operate the processor 10, etc. As discussed herein, it is appreciated that the game functionality discussed will be provided for in the software 22. For convenience and clarity, the game will primarily be discussed, and not the software which includes the programming language necessary to create the game.

The game may be programmed to allow the user to control the lights 26 while performing dance moves. The lights 26 may be 3-color LED's, for example, which may be selectively controlled to provide almost any desired color of light. The game may allow the user to select which lights are to be illuminated during certain portions of the dance routine, as well as select different lighting effects. Lighting effects may include blinking lights 26, fading the lights in and out, changing the color of the lights, etc. The game may allow a person to switch back and forth between different lighting effects for different portions of the game, such as different time segments. Alternatively, the game may allow for control of the lights based on pressing the controller buttons 30 or based on the acceleration forces placed on the controllers. Motion sensitive controllers 18 may include accelerometers for use in determining the movement experienced by the controllers. These accelerometers may be used to vary the lighting effects. For example, controller acceleration below a certain value may result in blue lights while acceleration above the value may result in red lights, flashing lights, etc. Thus, if the controller 18 is moved in a circle, moving the controller past a certain speed will result in sufficient acceleration to change the color of the lights. This may be particularly advantageous when the user is stringing.

The controller 18 may also include a mount 34, such as an eye or hook, which may be used to attach a string or line to the controller, allowing the controller to be swung around for stringing. Thus, the controller 18 allows for many different styles of dance, such as glow sticking or stringing. A string 36 may be attached to the mount 34, and may be provided with a loop or ring 40. The ring 40 may be placed on a users finger or held in the user's hand for stringing (swinging the controller about on the string 36). Thus, a user may move back and forth between glow sticking and stringing during a dance routine by releasing the controller and holding onto the ring 40 or string 36, or by alternatively recapturing the controller body after stringing.

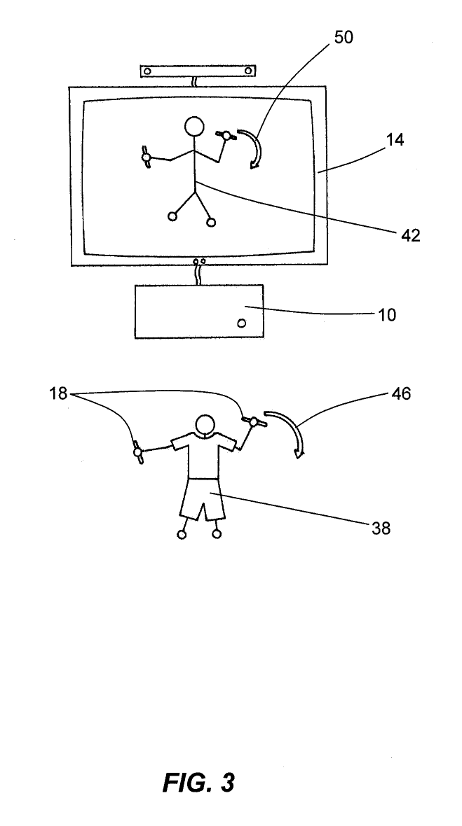

Turning now to FIG. 3, a schematic view of a person using the system of the present invention is shown. A person 38 is holding a pair of controllers 18 as may be used for glow sticking. The processor 10 senses and tracks the movement of the person 38 and displays a character 42 or representation of the person on the display 14. As the person moves, such as indicated by arrow 46, the corresponding movement is shown on the display, as indicated by arrow 50. Thus, the system tracks the movement of the person 38 and shows the movement on the display 14, allowing the person to observe the movements.

The system achieves several advantages by displaying the dance movements on the display 14. One advantage is that the person 38 is able to see what his dance moves look like from an observer's standpoint. Thus, the person 38 is better able to learn and practice moves and visualize dance techniques. Another advantage is that the system may display what the dance moves may look light under different conditions than the ambient conditions where the person 38 is practicing. The person may practice in their home during daylight, but the game may be configured to display how the moves would look when performed in a dance club with lower light levels, and may even include background images such as other dancers, and even other dancers who are glow sticking. The game may allow the user to select the background environment which is displayed, or otherwise enhance the visual demonstration (i.e. changing speed or other characteristics).

Similarly, the game may allow the user 38 to select the appearance of the character 42 which is displayed. The user 38 may select the hair color, height, or build of the character 42, and may even be allowed to select the clothing which the character wears. It will be appreciated that different clothing may affect the resulting appearance of the dance routine which the person 38 performs. Metallic clothing may reflect the light from the glow sticks. UV responsive or glow in the dark clothing may also be illuminated by the glow sticks or other glowing devices used by a person while at a club. Thus, the game may allow the user 38 to select a desired style, type, color, etc. of clothing to simulate clothing worn at a club.

The game may also allow a person to record 38 a dance routine/light show on a removable flash drive or onboard memory. The person may then play back the routine to watch and analyze the routine, or to share the routine with friends. The system may allow the user to change the lighting effects which are displayed or the clothing worn by the character 42 and replay the routine; allowing the person to easily determine which lighting effects or clothing will best compliment their dance routine. The ability to save different dance routines or moves may allow a person to track progress while learning or to compare changes to a routine to evaluate the same.

The game can be used for practice in the context of visualization of the moves as discussed above, or may be played in a mode which allows for scoring. For example, the game may walk a user through a number of moves. The game tracks the movement of the controllers 18 and evaluates how similar the movement of the controllers is to the movements instructed by the game. The user is then given a score which indicates how well the user tracked to prescribed movements. Multiple players can take turns to see who can get the highest score. As a player's scores increase, he or she may then more up to harder routines. Thus, a social activity/competition can be made out of practicing the various moves shown in the game while at the same time improving one's skills at glow sticking or stringing.

The game may even be used with highly accomplished dancers to see how well they can match the moves of the machine. Thus, dance clubs could have glow sticking competitions to see who can get the highest score. If the lights 26 are made in a similar appearance to a glow stick, the audience may watch numerous performers and then be informed their scoring according to the game to see if the best looking performance actually achieved the highest score.

In such a manner, the present invention provides both entertainment and social interacting in conjunction with practice. The increased activity may also have health benefits for young people who otherwise do not get adequate exercise.

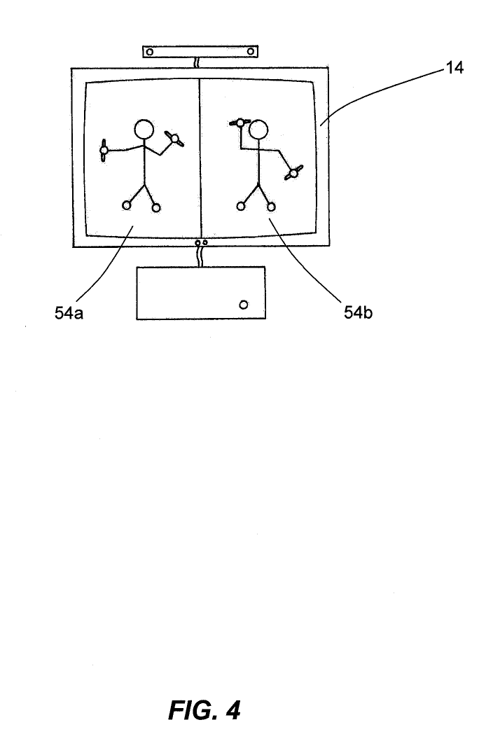

Turning now to FIG. 4, a front view of the display 14 is shown. The game is g operating in a split screen mode, displaying two separate screen sections 54a, 54b on the display 14. The game may utilize such a split screen mode for a variety of purposes. In a training mode, the game may show a user how to perform certain dance techniques with a computer-controlled character displayed in the first screen section 54a, and display the user's moves in the second section 54b. Thus, the user may watch the computer and match the moves. As such, the game may provide an excellent method of learning dance moves or techniques.

Additionally, the game may allow for competition between two or more individuals. A computer player may be displayed in one screen section and the user displayed in a second section. Alternatively, multiple persons may be displayed in the different sections of the screen. Thus, two or more persons may compete with each other using the game system of the present invention. The internet connectivity provided for by currently available gaming system may be used in the present system to allow persons in different geographical locations to compete against each other. Additionally, people from different locations may connect their systems over the internet to share moves, teach each other new moves, etc. Thus, the present system allows users to learn and share dance moves with different users in different locations, such as in different countries.

According to one aspect of the invention, the game may be played in a competition mode where the players are scored. The game may analyze the movements of the players to determine how smoothly, quickly, precisely, etc. their movements are executed. This information may be used to determine both how complicated the movements are and how well the movements are performed. The game may be programmed to recognize sequences of moves or particular moves to determine how well the move was performed. After performing a dance routine or move sequence, the game can tell the user how fast they are moving, how well the move was performed, how difficult the move was, etc. The players may be given points based on the sequences of moves, complexity of moves, precision of moves, etc.

The game may also provide different levels of play, such as beginner, intermediate, and advanced modes. On each level, the game may require increasingly difficult moves, increasing precision or skill, etc. The game may require a player to work through different levels, each level requiring more difficult or complex moves or combinations of moves to be performed by the player. The game may show or describe moves and sequences of moves to the player and then require the player to perform the moves to pass the level. Thus, the game becomes both a teaching medium as well as entertainment.

The game may contain different styles of glow sticking or stringing, such as may be performed in different countries or areas of the world. Thus, a player may learn new styles of dance moves from the game. As mentioned, the game system may be networked over the internet to communicate with different users in different areas of the world, providing for sharing of dance moves and styles.

The game may also have a freestyle mode, where a player does not have to complete specified moves, but is able to perform their own dance routines. The game may, if desired, analyze the moves performed by the player and rate the moves or provide feedback to the player, providing for learning assistance. For example, the game may indicate to the player if movements which should be circular are not properly shaped or if movements unexpectedly speed up or slow down.

The game will typically provide background music for the players to dance to. The music may include techno music or similar types of music as these are commonly used at dance parties.

There is thus disclosed an improved light game for practicing glow sticking, stringing, and other dance styles involving lights. It will be appreciated that numerous changes may be made to the present invention without departing from the scope of the claims.

What is claimed is:

1. A system for practicing dance moves comprising:
at least one controller, the controller comprising motion sensors disposed therein such that the controller can sense the movement of the controller;
a processor disposed in communication with the at least one controller;
an electronic display disposed in communication with the processor; and
software, the software being configured to allow a person to hold the controllers and to perform dance moves therewith and to display a representation of a person performing said dance moves on said electronic display and for causing said controllers to be represented by a lighting effect on said display such that the combination of the movement of said controllers and said lighting effect produce a light show on said display.

2. The system of claim 1, wherein said software is configured for allowing a user to select said lighting effect to thereby vary said light show produced on said display.

3. The system of claim 1, wherein said light show comprises a computer character which resembles a human and which moves so as to represent the motion of said person and wherein said at least one light effect comprises an illuminated object which corresponds to the controller and which moves so as to represent the motion of said at least one controller.

4. The system of claim 1, wherein the controller is represented on the display by an illuminated object and wherein the illuminated object is moved on the display to correspond to the movements of the controller.

5. The system of claim 1, wherein the software comprises a plurality of dance moves and wherein the system is configured to recognize movements of the controller which correspond to the plurality of dance moves and display the corresponding dance move on the display in response to movements of a user.

6. The system of claim 7, wherein each of the plurality of dance moves is associated with corresponding gesture, the gesture comprising a typical output from the controller motion sensors when a user performs the dance move.

7. The system of claim 1, wherein the motion sensors comprise accelerometers on three axes.

8. A method of practicing dance moves comprising:
selecting an electronic system including software, a processor, an electronic display, and at least one controller;
a person holding said at least one controller and moving in a dance movement so as to move said at least one controller about in said dance movement;
the processor tracking the movement of the at least one controller;
the processor displaying the movement of said controller on said electronic display by displaying an image of a light emitting object whose movement corresponds to said movement of said at least one controller.

9. The method of claim 8, wherein the method comprises the process of displaying the movement of said person on said electronic display by displaying a computer character which resembles a person and which moves so as to display the movement of said person.

10. The method of claim 9, wherein the method comprises:
selecting a controller which contains motion sensors therein;
transmitting information from the motion sensors to the processor;
the processor analyzing the motion to determine how the controller was moved; and
the processor displaying an image on the electronic display which corresponds to the movement of the controller.

11. The method of claim 10, wherein the method comprises:
the processor receiving information from the motion sensors indicative of the movement of the controller;
the processor comparing the information to pre-recorded gestures, the gestures corresponding to dance moves;
the processor identifying one or more gestures which correspond to the movement of the controller; and
the processor displaying one or more dance moves on the electronic display which correspond to the identified gestures.

12. The method of claim 8, wherein the method comprises: providing a video image of a series of dance moves and monitoring the movement of the at least one controller to determine the accuracy of the person in repeating the dance moves.

13. The method of claim 12, wherein the method comprises generating a score based on the accuracy of the person repeating the dance moves.

14. The method of claim 8, wherein the method comprises displaying patterns of moving lights similar to that observed by a person watching lights moving in an area having low ambient light.

15. A method for conducting a contest, comprising the method of claim 8 and further comprising monitoring movements of the at least one controller for at least two people performing the dance moves, and calculating a score for each of the at least two people based on detected movements of the controller.

16. A method for conducting a contest comprising the method of claim 8, wherein the method further comprises displaying a first image of the light emitting object for a first person in accordance with the tracked movements of the at least one controller and displaying a second image of a light emitting object for a second person in accordance with tracked movements of the at least one controller.

17. A method of claim 16, wherein the method comprises diplaying the first image of the light emitting object and the second image of the light emitting object on a common display.

18. The method of claim 17, wherein first person is using a different controller of the at least one controller than a controller used by a second person.

19. The method of claim 17, wherein the first person is dancing in a first location and wherein the second person is dancing in a second location remote from the first location.

20. The method of claim 17, wherein the method further comprises generating a score for the first person and a score for the second person based on movements of the at least one controller by each of the first person and the second person.

21. A method for learning dance moves, the method comprising:
showing a visual representation of a dance move;
a person repeating the dance move while holding at least one controller;
sensing the movement of the at least one controller; and
providing of a visual representation of the movement of the person based on the sensed movement of the at least one controller.

22. The method according to claim 21, wherein the method comprises displaying a light show representative of a person dancing with a glow stick based on the movements of the person as determined by sensing the movement of the at least one controller.

23. The method according to claim 21, wherein the method comprises scoring the person based on accuracy of the repeated dance move as determined by the sensed movement of the at least one controller.

24. The method according to claim 21, further comprising:
showing a visual representation of a series of dance moves
the person repeating the series of dance moves while holding at least one controller;
sensing the movement of the at least one controller; and
providing of a visual representation of the movements of the person based on the sensed movement of the at least one controller.

25. The method according to claim 24, wherein the method further comprises adjusting the difficulty of the dance move based on a determined level of accuracy in the person performing the series of dance moves.

26. The method according to claim 21, comprising having at least two persons repeat the dance move while holding at least one controller and giving a score to each of the persons determined by sensed movement of the at least one controller.

27. The method according to claim 26, wherein the method further comprises providing a visual representation of the movements of at least two persons based on the sensed movement of the at least one controller on a common display.

28. A method for playing a game comprising:
performing a plurality of dance moves while holding a wireless controller so as to simulate dancing with a light emitting object;
sensing movement of the controller;
producing a visual reproduction of the movements of the light emitting object so as to produce a light show representative of the dance moves; and
establishing a score based on the sensed movements.
